(19) United States
(12) Patent Application Publication
(10) Pub. No.: US 2004/0204058 A1
(43) Pub. Date: Oct. 14, 2004

(54) Integrated multi-purpose wireless network transceiver

(76) Inventor: Cheng-Yang Huang, Taichung (TW)

Correspondence Address: BRUCE H. TROXELL, Suite 1404, 5205 Leesburg Pike, Falls Church, VA, 22041, US

(21) Appl. No.: 10/319,461

(22) Filed: Dec. 16, 2002

(51) Int. Cl. H04B 1/38; H04M 1/00

(52) U.S. Cl. 455/556.1; 455/90.1; 455/550.1; 455/575.1

(57) ABSTRACT

An integrated multi-purpose wireless network transceiver comprises a case holding a wireless network card or wireless network access device through wireless transmission to interface with the computer server at a client or access end, a flipping device on top, a holder for memo paper and a knob to support an upright pen holder. The flipping device comprises a preset board and a connected flipping cover. On top of the preset board, there is an electronic calculator module for numerical calculation. Below the electronic calculator module, an electronic clock and calendar, module are connected to set time, alarm and calendar. At the inner side of the flipping cover, there is a display available to show the formula and results for the electronic calculator, and the time and date for the electronic clock. This integrated design is provided to the multi-purpose wireless network transceiver for the present invention.

### FIELD OF THE INVENTION

The present invention is related to an integrated multi-purpose wireless network transceiver. Especially, it means an interface that can be connected to user terminal or access terminal for computer server to make wireless transmission. Besides original wireless transmission, it further provides a number of functions like an electronic calculator, an electronic clock, an electronic calendar, a memo paper holder, and a pen holder. It provides users with a wireless transmission device that possesses aesthetic appearance and multiple integrated functions.

### BACKGROUND OF THE INVENTION

In general, the network connection for computer server is made through a network card in local area network. Such a device that requires wire connection usually limits the placement flexibility due to network wire for connecting hardwares. The space utilization will also be affected. Further, connecting wire does not give aesthetic appearance for interior design. Thus, the present market trend is to use the wireless network transceiver to provide placement flexibility and the optimal space utilization. Besides, no exposed wire exists to affect the entire aesthetic feeling in this application.

However, the current wireless network transceiver is of single purpose in a really boring style. Further, it takes up certain space without giving interesting feeling.

In view of this, since the wireless network transceiver is currently a necessary equipment, the inventor for the present invention proposed an integrated multi-purpose wireless network transceiver, so it not only provides the original wireless transmission but also a number of other functions like an electronic calculator, an electronic clock, an electronic calendar, an electronic recorder, a memo paper holder and a pen holder. It further provides a transceiver with aesthetic appearance and multiple purposes. This is the objective for the present invention.

The following gives detailed explanations for an embodiment with figure for the integrated multi-purpose wireless network transceiver for the present invention.

### BRIEF DESCRIPTION OF THE DRAWINGS

FIG. 1 is an appearance for the present invention.

FIG. 2 is an appearance for an embodiment for the present invention.

FIG. 3 is an illustration for the flipping device in closure state for the present invention.

FIG. 4 is an illustration for the present invention from another view angle.

FIG. 5 is an appearance for another preferred embodiment for the present invention.

### DETAILED DESCRIPTION OF THE INVENTION

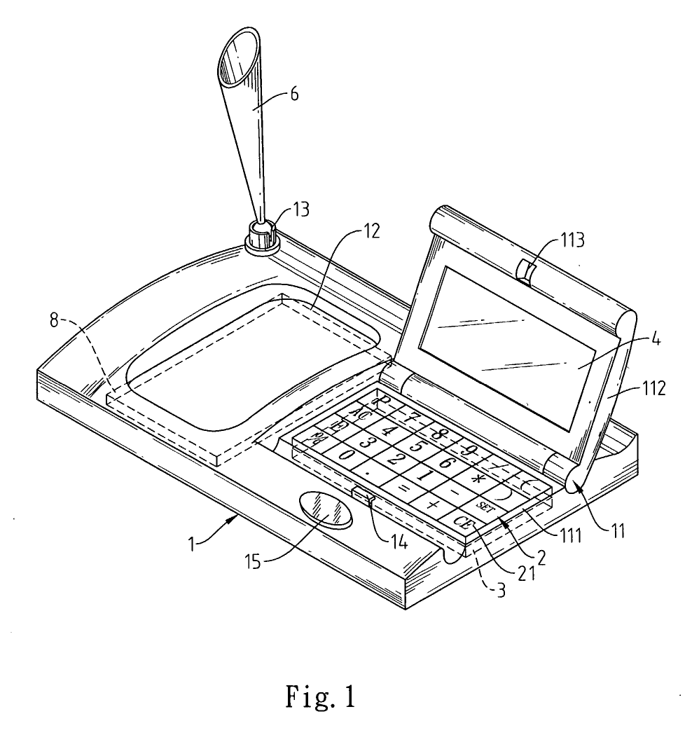

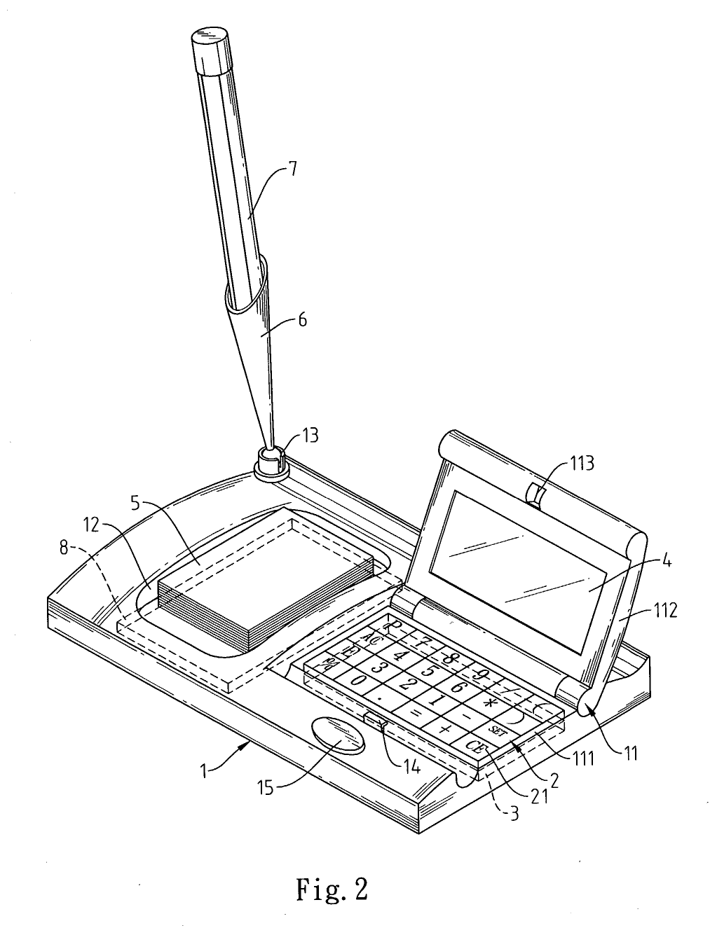

Please refer to FIGS. 1 and 2. The present invention is composed of a case 1 containing a wireless network card or wireless network access device 8, a flipping device 11 on top, a storage holder 12 and an upright knob 13. The flipping device 11 comprises a preset board 111 and a connected flipping cover 112. On top of the preset board 111, there is an electronic calculator module 2, whose bottom is connected to an electronic calendar module 3. On the inner side of the flipping cover 112, there is a display 4. The electronic calculator module 2 is used for numerical calculation. The numerical formula and the calculated result will be shown on the display 4. The electronic clock and calendar module 3 is provided to set time, alarm and date. Through keypad 21, the setting can be entered and shown on the display 4.

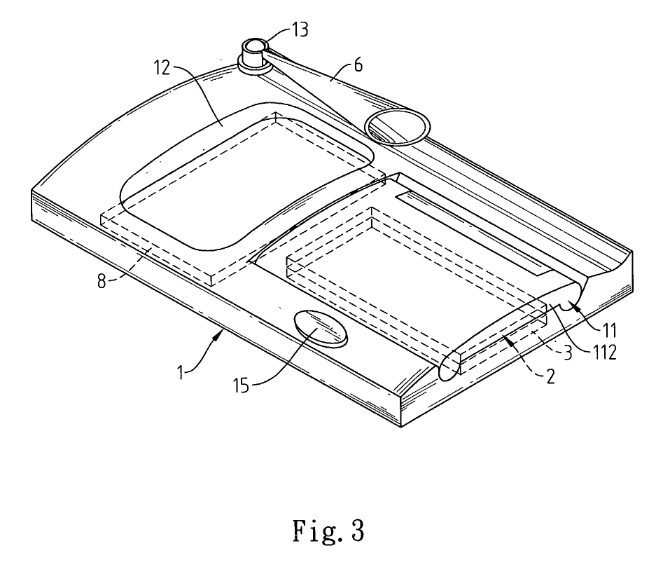

Besides, there is a tab 14 at the front edge of the flipping device 11 for the case 1. The tab 14 position can be adjusted by a button 15 at the front edge of the case 1. At the front edge of the inner side of the flipping cover 112, there is a hole 113 for the tab 14 to lock in when the flipping cover 112 is closed. Thus, the flipping cover 112 and the preset board 111 will be positioned to match for each other (as shown in FIG. 3). When the button 15 is pressed, the tab 14 will detach from the hole 113 and the flipping cover 112 will open up automatically. Thus, the preset board 111 is in an open state and users can see the content on the display 4.

The storage holder 12 is provided for holding memo paper 5. The knob 13 on the case 1 is provided for supporting a pen holder 6 for holding a pen 7. In addition, the knob 13 provides multi-angle rotation for the pen holder 6 to change angle.

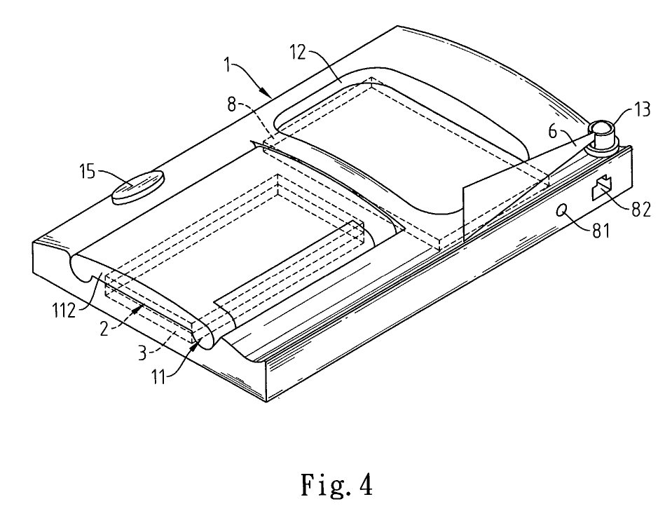

As shown in FIG. 4, the wireless network card or wireless network access device 8 is contained in the case 1. A power socket 81 and a connection port 82 are on the exterior of the case 1. The power socket 81 is for external power source for the electronic calculator module 2, the electronic clock and calendar module 3 and the wireless network card or wireless network access device 8 to allow operation for the electronic calculator module 2 and the electronic clock and calendar module 3 and allow the wireless network card or wireless network access device 8 to transmit and receive wireless signals. The connection port 82 is used as an interface for wireless communication of computer server with user terminal or access terminal.

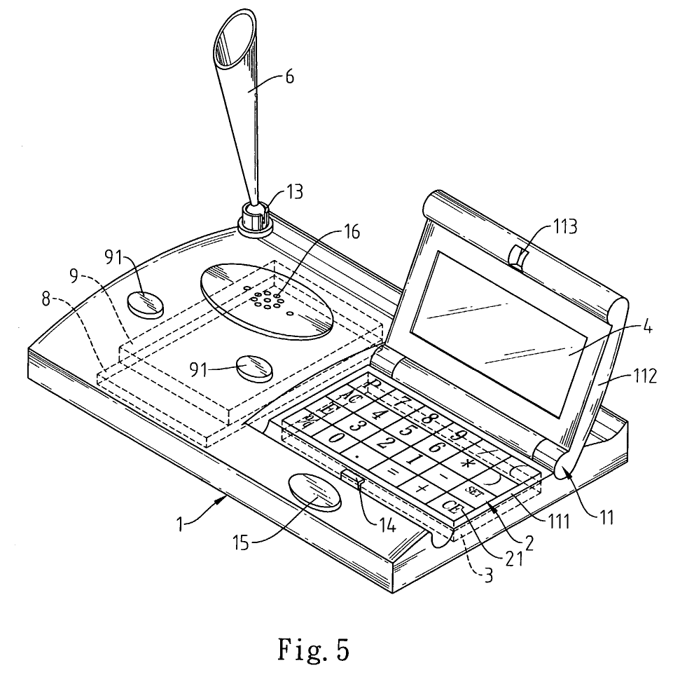

As shown in FIG. 5, the integrated multi-purpose wireless network transceiver for the present invention, one side of the flipping device 11 in the case 1 can be curved to replace the storage holder 12. Below the curved side, there can be an electronic recorder module 9 with the sound recording button 91 on the surface of the case 1. There are several sound holes 16 on the curved surface, through which the electronic recorder module 9 to receive or transmit sound.

From the above description, it is known that the present invention provides an integrated multi-purpose wireless network transceiver for use as an interface between computer server and user terminal or access terminal. In this way, in addition to the original wireless transmission, it further provides a number of functions like an electronic calculator, an electronic clock, an electronic calendar, a memo paper holder, and a pen holder. It provides users with a wireless transmission device that possesses aesthetic appearance and multiple integrated functions.

Nevertheless, the above-disclosed figures are only meant to describe one embodiment for the present invention. The present invention provides an integrated multi-purpose wireless network transceiver for user convenience and reduced cost and different market demands. The multi-purpose integrated configuration design adopts independent modules and a necessary structure that is the case to hold the wireless network card or wireless network access device. The other modules are optional and chosen as necessary.

What is claimed is:

1. An integrated multi-purpose wireless network transceiver, comprising a case holding a wireless network card or wireless network access device through wireless transmission to interface with a computer server at a client or access end, a flipping device on top, a holder for memo paper, and a knob to support an upright pen holder, said flipping device composed of a preset board and a connected flipping cover, on top of said preset board, there being an electronic calculator module for numerical calculation, below said electronic calculator module, an electronic clock and calendar module being connected to set time, alarm and calendar, at an inner side of said flipping cover, there being a display available to show formula and results for said electronic calculator, and time and date for said electronic clock, this integrated design being provided to an integrated multi-purpose wireless network transceiver for present invention with wireless network transmission, an electronic calculator, an electronic clock, an electronic calendar, a storage holder and a pen holder.

2. The integrated multi-purpose wireless network transceiver of claim 1, wherein there is a tab at a front edge of said flipping device for the case, position of said tab can be adjusted by a button at a front edge of said case.

3. The integrated multi-purpose wireless network transceiver of claim 1, wherein at a front edge of an inner side of said flipping cover, there is a hole for said tab to lock in when said flipping cover is closed, thus, said flipping cover and preset board will be positioned to match for each other.

4. The integrated multi-purpose wireless network transceiver of claim 1, wherein said wireless network card or wireless network access device is contained in said case, a power socket and a connection port are on an exterior of said case, said power socket is for external power source for said electronic calculator module, electronic clock and calendar module and wireless network card or wireless network access device to allow operation for said electronic calculator module and electronic clock and calendar module and allow said wireless network card or wireless network access device to transmit and receive wireless signals.

5. The integrated multi-purpose wireless network transceiver of claim 1, wherein on top of said case, under one side of said flipping device, there can contain a built-in electronic recorder module to provide a recording function.

6. The integrated multi-purpose wireless network transceiver of claim 5, wherein a sound recording button for said electronic recorder module is on an exterior of said case, said case also possesses several sound holes, through said sound holes, sound is received and transmitted.
